(19) United States
(12) Patent Application Publication
(10) Pub. No.: US 2012/0038592 A1
(43) Pub. Date: Feb. 16, 2012

(54) INPUT/OUTPUT DEVICE AND HUMAN-MACHINE INTERACTION SYSTEM AND METHOD THEREOF

(75) Inventors: Jyh-Horng Shyu, Hsinchu (TW); Po-Chuan Kang, Hsinchu (TW)

(73) Assignee: YOUNG OPTICS INC., Hsinchu (TW)

(21) Appl. No.: 13/046,790

(22) Filed: Mar. 14, 2011

(30) Foreign Application Priority Data
Aug. 11, 2010 (CN) 201010255980.1

(51) Int. Cl. G06F 3/042

(52) U.S. Cl. 345/175

(57) ABSTRACT

An input/output device and human-machine interaction system and method thereof are provided. The input/output device includes a projection module, an image capturing module and a processing module. The projection module is capable of receiving an image provided by a mobile computing device and projecting the image onto a surface. The image capturing module is capable of capturing a user's operation action on a projected image on the surface to thereby provide operation information. The processing module is electrically connected with the image capturing module for receiving and processing the operation information to thereby generate an operation command to correspondingly control the mobile computing device.

### CROSS-REFERENCE TO RELATED APPLICATION

This application claims the priority benefit of China application serial no. 201010255980.1, filed on Aug. 11, 2010. The entirety of the above-mentioned patent application is hereby incorporated by reference herein and made a part of this specification.

### BACKGROUND OF THE INVENTION

1. Field of the Invention

The invention relates to an input and output (I/O) device, and more particularly, to an I/O device connected with a mobile computing device and human-machine interaction system and method thereof.

2. Description of Related Art

With the touch technology maturing, more and more mobile computing devices (for example, smart touch phone, personal digital assistant (PDA), portable media player (PMP) or the like) are using the touch panel as a human-machine interface. However, the mobile computing devices using the touch panel are usually equipped with a touch screen having a size less than 5 inches. As such, the small touch screen not only causes inconveniences in viewing images (for example, movies or articles), but also may cause the mobile computing device to be difficult to use in some touch input situations. For example, the area of the finger tip is larger than icons displayed on the screen.

In addition, current interaction systems including an image capturing device and a projection device are usually large-sized interaction systems. The relative position between the image capturing device and the projection device is not fixed. Therefore, before interaction, the projection device must project position points of a projection coordinate, and the user then sequentially touches or clicks respective position points, such that the image capturing device can detect the position points of the image the user touches or clicks, thus completing the positioning procedures.

However, once the image capturing device or the projection device is slightly moved, repositioning is required, which can be rather troublesome. In addition, Light Blue Optics Company also discloses a mobile optical touch interaction device, called Light Touch, the mobile optical touch interaction device projects image data stored in a memory utilizing a laser light source and holographic technology. Although this optical touch device can be connected with an external electrical device in a wired or wireless manner to transmit the image data to an internal memory, but it cannot display the image in synchronization with the external electrical device.

### SUMMARY OF THE INVENTION

Accordingly, the invention is directed to an input/output (I/O) device connected with a mobile computing device and human-machine interaction system and method thereof which can effectively overcome one or more of the aforementioned problems.

One embodiment of the invention provides an I/O device. The I/O device includes a projection module, an image capturing module and a processing module. The projection module is capable of receiving an image provided by a mobile computing device and projecting the image onto a surface. The image capturing module is capable of capturing a user's operation action on the image on the surface to thereby provide operation information. The processing module is electrically connected with the image capturing module for receiving and processing the operation information to thereby generate an operation command to correspondingly control the mobile computing device.

In one embodiment, the I/O device further includes an I/O interface electrically connected with the projection module and the processing module. The I/O interface obtains image data provided by the mobile computing device in a wired or wireless manner and provides the image data to the projection module for projection.

In one embodiment, the I/O interface further transmits the operation command to the mobile computing device in a wired or wireless manner, such that the mobile computing device operates in response to the operation command.

In one embodiment, the projection module may include a plurality of sub-projection modules. The I/O device may further include a projection splitting/merging module. The projection splitting/merging module is electrically connected between the I/O interface and the plurality of sub-projection modules to receive and process the image data provided by the mobile device and obtained by the I/O interface and provide the image data to the plurality of sub-projection modules for projection.

In one embodiment, the image capturing module may include a plurality of sub-image capturing modules for capturing the user's operation action on the projected image to thereby provide the operation information to the processing module.

In one embodiment, the I/O device may further include an auxiliary illumination light source module. The auxiliary illumination light source module is capable of transmitting an invisible light onto the projected image so as to assist the image capturing module to capture the user's operation action on the projected image.

In one embodiment, the projection module may be a pico-projection module, and the sub-projection modules may be a pico-projection module.

In one embodiment, the sub-projection modules receive a plurality of images provided by the mobile computing device and processed by the projection splitting/merging module and may sequentially project the plurality of images onto the surface, and the plurality of images overlap on the surface.

In one embodiment, the sub-projection modules receive a plurality of images provided by the mobile computing device and processed by the projection splitting/merging module, the sub-projection modules may project the plurality of images onto the surface at the same time, and the plurality of images are projected to different positions on the surface.

In one embodiment, each of the image capturing modules may be a camera module, and the sub-image capturing modules may be a camera module.

In one embodiment, the mobile computing device comprises at least one of a smart touch phone, a personal digital assistant and a portable media player.

Another embodiment of the invention provides a human-machine interaction system. The human-machine interaction system includes a mobile computing device and an I/O device. The I/O device is connected with the mobile computing device in a wired or wireless manner, for projecting an image displayed by a mobile computing device onto a surface and capturing a user's operation action on the projected image on the surface to thereby control the mobile computing device correspondingly.

Still another embodiment of the invention provides a human-machine interaction method. The method includes: receiving an image data of a mobile computing device; projecting an image displayed by a mobile computing device onto a surface, such that the surface has a projected image; capturing a user's operation action on the projected image and generating operation information; receiving the operation information to thereby generate an operation command; and driving the mobile computing device to operate in response to the operation action.

In view of the foregoing, in embodiments of the invention, the I/O device can convert the relatively small image displayed on the mobile computing device into a larger projected image on any surface. As such, the user not only can watch movies or read articles on the projected image on the surface, but also can operate on the projected image on the surface to thereby control the mobile computing device.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a block diagram of a human-machine interaction system according to one embodiment of the invention.

FIG. 2 is a view showing using state of the human-machine interaction system.

FIG. 3 is a block diagram of the I/O device according to one embodiment of the invention.

FIG. 4 illustrates a flowchart of a human-machine interaction method according to one embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purposes of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

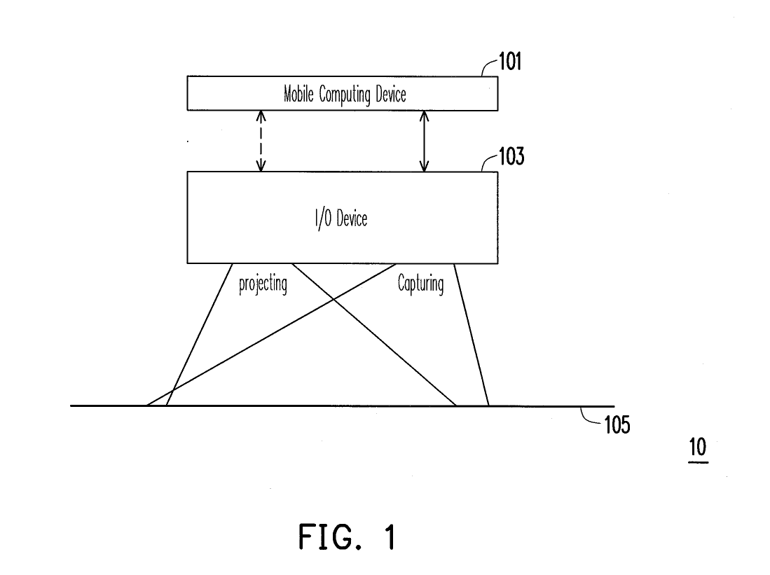

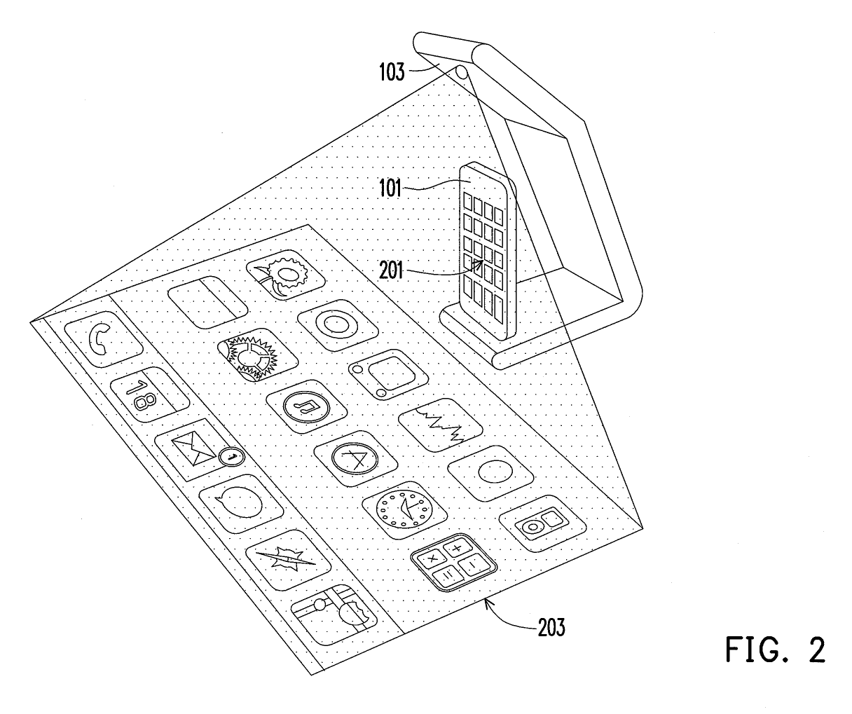

FIG. 1 is a block diagram of a human-machine interaction system 10 according to one embodiment of the invention. FIG. 2 is a view showing a using state of the human-machine interaction system 10. Referring to FIG. 1 and FIG. 2, the human-machine interaction system 10 includes a mobile computing device 101 and an I/O device 103. In the embodiment, the mobile computing device 101 may be, but not limited to, one of a smart touch phone, a personal digital assistant (PDA) and a media player.

The I/O device 103 may be connected with the mobile computing device 101 in a wired manner such as RS232 or universal serial bus, or in a wireless manner such as 802.11 a/b/g/n, blue tooth or radio frequency. Alternatively, the I/O device 103 may be directly electrically connected to the mobile computing device 101 to project an image 201 displayed by the mobile computing device 101 onto a surface (for example, but not limited to, a desktop 105), and capture a user's operation action on the projected image 203 on the desktop 105 to thereby correspondingly control the operation of the mobile computing device 101.

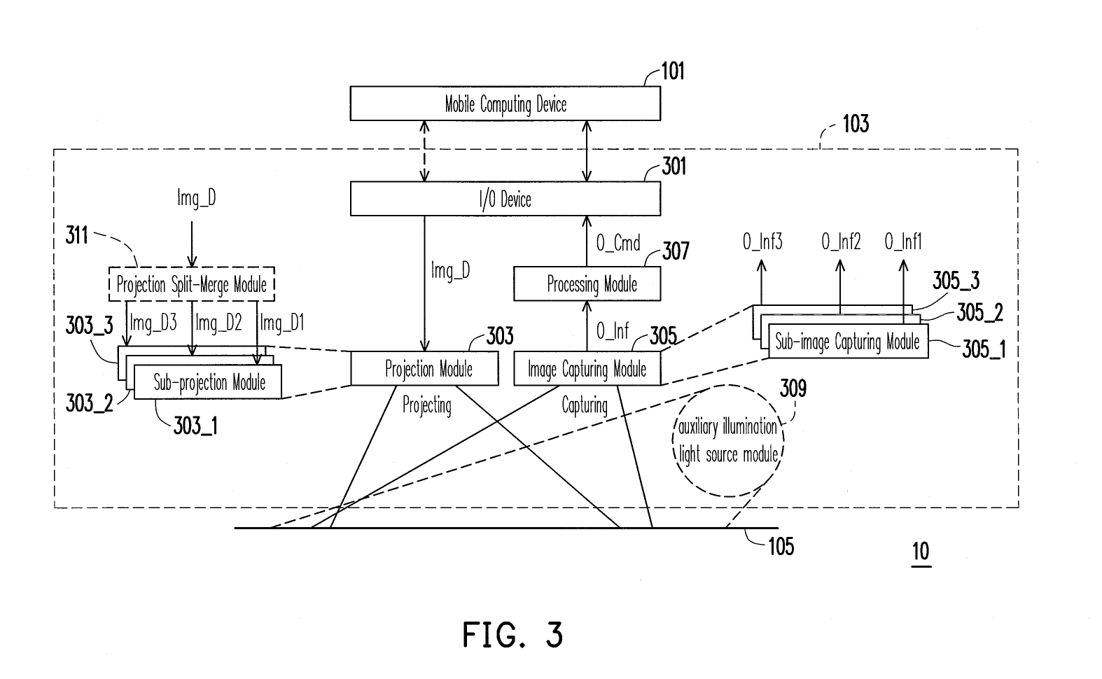

More specifically, FIG. 3 is a block diagram of the I/O device 103 according to one embodiment of the invention. Referring to FIG. 1 to FIG. 3, the I/O device 103 includes an I/O interface 301, a projection module (for example, a pico-projection module) 303, an image capturing module (for example, but not limited to, a camera module) 305, and a processing module 307.

In the embodiment, the I/O interface 301 is electrically connected with the projection module 303 and the processing module 307. The I/O device 301 can obtain image data Img_D of the image 201 displayed by the mobile computing device 101 and provide the image data Img_D to the projection module 303 for projection. As such, the projection module 303 can project the image 201 displayed by the mobile computing device 101 onto the desktop 105, such that the desktop 105 has the projected image 203 thereon.

The image capturing module 305 is electrically connected with the processing module 307 to capture the user's operation action (for example, a touch position on the projected image 203 or a gesture made on the projected image 203) on the projected image 203, and then provide operation information O_Inf to the processing module 307. The processing module 307 is capable of receiving and processing the operation information O_Inf provided by the image capturing module 305 to generate an operation command O_Cmd.

Similarly, the I/O interface 301 can likewise transmit the operation command O_Cmd generated by the processing module 307 to the mobile computing device 101 in a wired or wireless manner, such that the processing module 307 can correspondingly control the operation of the mobile computing device 101. In other words, the mobile computing device 101 operates in response to the operation command O_Cmd of the processing module 307.

In view of the foregoing, the user may touch or gesture on the projected image 203 to correspondingly control/operate the mobile computing device 101. As such, the user not only can watch movies or read articles on the projected image 203 on the desktop 105, but also can operate icons on the projected image 203 on the desktop 105 to thereby easily control/operate the mobile computing device 101. In addition, the embodiment also allows multiple users at the I/O device 103 end and at the mobile computing device 101 end to operate and control the mobile computing device 101, respectively, in a wired or wireless manner. That is, the user's operation action at the I/O device 103 end can be synchronously displayed on the mobile computing device 101 end, and the user's operation action at the mobile computing device 101 end can also be synchronously displayed on the I/O device 103 end, thus achieving an interaction effect.

Viewed from another aspect, the pico-projection module projects a large image using a small device, and the image capturing module captures a large image using a small device. Therefore, a combination of the two modules can achieve that a small device generates a large image. In addition, proper overlap of the projected image and the captured image can achieve a direct interaction operation.

More specifically, in the foregoing embodiment, the projection module 303 and the image capturing module 305 may use different lenses to form two separate modules. It is noted, however, that the projection imaging and optical image capturing have a particular and preset relationship with respect to their positions (for example, the distance between centers of the two lenses of the projection module 303 and the image capturing module 305 must be kept within a particular and preset range, i.e. the projection module 303 and the image capturing module 305 have a fixed positional relationship therebetween.) As such, the user can control/operate the mobile computing device 101 by operating the projected image 203 on the desktop 105 without pre-position and calibration before use.

In other embodiments of the invention, the projection module 303 and the image capturing module 305 can also share one lens such that they are integrated into a single module. Since the projection module 303 and the image capturing module 305 share one lens and are integrated into a single module, the projection module 303 and the image capturing module 305 have a fixed positional relationship therebetween. As such, likewise, the user can control/operate the mobile computing device 101 by operating the projected image 203 on the desktop 105 without pre-position and calibration before use.

On the other hand, in order to make the image capturing module 305 more accurately capture the user's operation action on the projected image 203 and in order to simplify the data processing of the processing module 307, the I/O device 103 may be further provided with an auxiliary illumination light source module 309 as shown in FIG. 3.

More specifically, the auxiliary illumination light source module 309 may provide a visible or an invisible light. For instance, the auxiliary illumination light source module 309 transmits an invisible light (for example, infrared light source) onto the projected image 203 to thereby assist the image capturing module 305 to accurately capture the user's operation action on the projected image 203. Since the image capturing module 305 obtains the user's operation action on the projected image 203 by capturing the invisible light, the image capturing module 305 can accurately capture the user's operation action on the projected image 203 while simplifying the data processing of the processing module 307.

Besides, in other embodiments of the invention, the projection module 303 may include a plurality of (for example, but not limited to, three) sub-projection modules 303_1 to 303_3 (each can be a pico-projection module). The I/O device 103 further includes a projection splitting/merging module 311 (as shown in FIG. 3).

More specifically, the projection splitting/merging module 311 is electrically connected between the I/O interface 301 and the sub-projection modules 303_1 to 303_3, for receiving and processing the image data Img_D of the image 201 displayed on the mobile computing device 101, splitting the image data Img_D into multiple pieces of splitting image data Img_D1, Img_D2 and Img_D3, and providing the splitting image data to the sub-projection modules 303_1 to 303_3 for projection. In other words, the images projected by the sub-projection modules 303_1 to 303_3 can be merged into the projected image 203, or merged into a projection image that is even larger than the projection image 203.

In addition, the projection splitting/merging module 311 may also split the image data Img_D into left-eye splitting image data Img_D1 and right-eye splitting image data Img_D2 and provide the left-eye splitting image data Img_D1 and right-eye splitting image data Img_D2 to two of the sub-projection modules 303_1 to 303_3 for projection, with the left-eye splitting image data Img_D1 and right-eye splitting image data Img_D2 sequentially overlapped to form a 3D image. As such, the user can view the stereoscopic image by wearing a pair of 3D eyeglasses which include a switching sequence for sequentially displaying left-eye and right-eye images.

On the other hand, in one of embodiments of the invention, the image capturing module 305 may also include a plurality of (for example, but not limited to, three) sub-image capturing modules 305_1 to 305_3. The sub-image capturing modules 305_1 to 305_3 are capable of capturing the user's operation action on the projected image 203 and thereby provide sub-image operation information O_Inf1, O_Inf2 and O_Inf3 to the processing module 307.

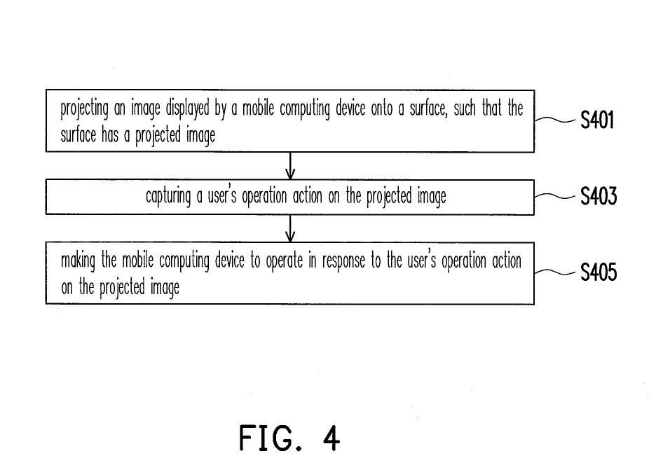

In view of the foregoing embodiments, the invention provides a human-machine interaction method. More specifically, FIG. 4 illustrates a flowchart of a human-machine interaction method according to one embodiment of the invention. Referring to FIG. 4, the human-machine interaction method of the embodiment includes the following steps. Firstly, an image displayed by a mobile computing device is projected onto a surface (for example, but not limited to, a desktop) using a projection module, such that the surface has a projected image (S401). User's operation action on the projected image on the surface is then captured by an image capturing module (S403). Finally, the mobile computing device is caused to operate in response to the user's operation action on the projected image on the surface (S405).

In summary, in the embodiments of the invention described above, the I/O device 103 can convert the relatively small image 201 displayed on the mobile computing device 101 into a larger projected image 203 projected onto any surface (for example, the desktop 105). As such, the user not only can watch movies or read articles on the projected image 203 on the surface (desktop 105), but also can operate on the projected image 203 on the surface (desktop 105) to thereby control the mobile computing device 101. In addition, in the above embodiments of the embodiment, the I/O device 103 may be of a fixed desktop type or portable, and the I/O device 103 allows one to convert a mobile computing device 101 into a desktop computer in various places, such as, restaurant, airport, hotel or the like, as long as a suitable desktop can be found.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. An input/output device comprising:
a projection module capable of receiving an image provided by a mobile computing device and projecting the image onto a surface, the projection module comprising a plurality of sub-projection modules;
an image capturing module capable of capturing a user's operation action on the image on the surface to thereby provide operation information;
a processing module electrically connected with the image capturing module capable of receiving and processing the operation information to thereby generate an operation command to correspondingly control the mobile computing device;
an input/output interface electrically connected with the projection module and the processing module, the input/output interface capable of obtaining an image data provided by the mobile computing device in a wired or wireless manner; and
a projection splitting/merging module electrically connected between the input/output interface and the plurality of sub-projection modules, the projection splitting/merging module capable of receiving and processing the image data provided by the mobile computing device and obtained by the input/output interface and providing the image data to the plurality of sub-projection modules for projection.

2. The input/output device according to claim 1, wherein the input/output interface further transmits the operation command to the mobile computing device in a wired or wireless manner, such that the mobile computing device operates in response to the operation command.

3. The input/output device according to claim 1, wherein the projection module is a pico-projection module or the sub-projection modules are a pico-projection module.

4. The input/output device according to claim 1, wherein the sub-projection modules receive a plurality of images provided by the mobile computing device and processed by the projection splitting/merging module and sequentially project the plurality of images onto the surface, and the plurality of images overlap on the surface.

5. The input/output device according to claim 1, wherein the sub-projection modules receive a plurality of images provided by the mobile computing device and processed by the projection splitting/merging module, the sub-projection modules project the plurality of images onto the surface at the same time, and the plurality of images are projected to different positions on the surface.

6. The input/output device according to claim 1, wherein the image capturing module comprises a plurality of sub-image capturing modules capable of capturing the user's operation action on the projected image to thereby provide the operation information to the processing module.

7. The input/output device according to claim 6, wherein the image capturing module is a camera module or the sub-image capturing modules are a camera module.

8. The input/output device according to claim 1, further comprising an auxiliary illumination light source module capable of transmitting an invisible light onto the projected image so as to assist the image capturing module to capture the user's operation action on the projected image.

9. The input/output device according to claim 1, wherein the mobile computing device comprises at least one of a smart touch phone, a personal digital assistant and a portable media player.

10. A human-machine interaction system comprising:
a mobile computing device; and
an input/output device connected with the mobile computing device in a wired or wireless manner, the input/output device comprising:
a projection module capable of projecting an image displayed by a mobile computing device onto a surface, the projection module comprising a plurality of sub-projection modules;
an image capturing module capable of capturing a user's operation action on the projected image to thereby provide operation information;
a processing module electrically connected with the image capturing module capable of receiving and processing the operation information to thereby generate an operation command to correspondingly control the mobile computing device; and
a projection splitting/merging module electrically connected between an input/output interface and the plurality of sub-projection modules, the projection splitting/merging module capable of receiving and processing image data provided by the mobile device and obtained by the input/output interface and provide the image data to the plurality of sub-projection modules for projection.

11. The human-machine interaction system according to claim 10, wherein the input/output interface is electrically connected with the projection module and the processing module, the input/output interface is capable of obtaining image data provided by the mobile computing device in a wired or wireless manner, and providing the image data to the projection module for projection.

12. The human-machine interaction system according to claim 10, wherein the input/output interface further transmits the operation command to the mobile computing device in a wired or wireless manner, such that the mobile computing device operates in response to the operation command.

13. The human-machine interaction system according to claim 10, wherein the projection module is a pico-projection module and the sub-projection modules are a pico-projection module.

14. The human-machine interaction system according to claim 10, wherein the image capturing module comprises a plurality of sub-image capturing modules capable of capturing the user's operation action on the projected image to thereby provide the operation information to the processing module.

15. The human-machine interaction system according to claim 14, wherein the image capturing module is a camera module and the sub-image capturing modules are a camera module.

16. The human-machine interaction system according to claim 10, wherein the input/output device further comprises an auxiliary illumination light source module capable of transmitting an invisible light onto the projected image so as to assist the image capturing module to capture the user's operation action on the projected image.

17. The human-machine interaction system according to claim 10, wherein the mobile computing device comprises at least one of a smart touch phone, a personal digital assistant and a portable media player.

18. A human-machine interaction method comprising:
receiving an image data of a mobile computing device;
projecting an image displayed by the mobile computing device onto a surface, such that the surface has a projected image;
capturing a user's operation action on the projected image and generating operation information;
receiving the operation information to thereby generate an operation command; and
driving the mobile computing device to operate in response to the user's operation action.

19. The human-machine interaction method according to claim 18, further comprising:
receiving a plurality of images provided by the mobile computing device and processed by a projection splitting/merging module; and
sequentially projecting the plurality of images onto the surface and the plurality of images overlapping on the surface.

20. The human-machine interaction method according to claim 18, further comprising:
receiving a plurality of images provided by the mobile computing device and processed by the projection splitting/merging module; and
projecting the plurality of images to different positions on the surface at the same time.
